(19) United States
(12) Patent Application Publication
(10) Pub. No.: US 2023/0015789 A1
(43) Pub. Date: Jan. 19, 2023

(54) AGGREGATION OF USER AUTHORIZATIONS FROM DIFFERENT PROVIDERS IN A HYBRID CLOUD ENVIRONMENT

(71) Applicant: VMware, Inc., Palo Alto, CA (US)

(72) Inventors: Sergio SANCHEZ, Sofia (BG); Georgi MULESHKOV, Sofia (BG); Tina NAKOVA, Sofia (BG)

(21) Appl. No.: 17/370,927

(22) Filed: Jul. 8, 2021

(51) Int. Cl. H04L 29/06; G06F 9/455

(52) U.S. Cl. CPC H04L 63/10; H04L 63/0815; G06F 9/45541

(57) ABSTRACT

An example method of aggregating authorization information for a user accessing a service executing in a virtualized computing system includes: receiving, at an authorities aggregating service (AAS) executing in the virtualized computing system, a request for an authorization context for the user from the service; requesting, by the AAS, authorization information from at least one authorization source registered with the AAS for the user; generating the authorization context by aggregating the authorization information; and returning the authorization context to the service.

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

Modern applications can be deployed in a hybrid cloud fashion, that is, consuming both cloud services and on-premises or local services. Such applications can rely on external or third-party single sign-on (SSO) solutions for initial authentication and authorization of users. In addition, such applications can rely on one or more custom authority models, such as role-based or permission-based models, to define and configured who can take what actions. It can be difficult to aggregate all the authorities that a user holds after authentication to make the proper authorization checks efficient within the application or service thereof that the user is accessing.

### BRIEF DESCRIPTION OF THE DRAWINGS

FIG. 1 is a block diagram of a virtualized computing system in which embodiments described herein may be implemented.

FIG. 2 is a block diagram depicting user interaction with an application according to an embodiment.

FIG. 3 is a flow diagram depicting a method of aggregating authorization information for a user according to an embodiment.

FIG. 4 is a flow diagram depicting a method of generating an authorization context for a user by aggregating authorization information from disparate sources according to an embodiment.

### DETAILED DESCRIPTION

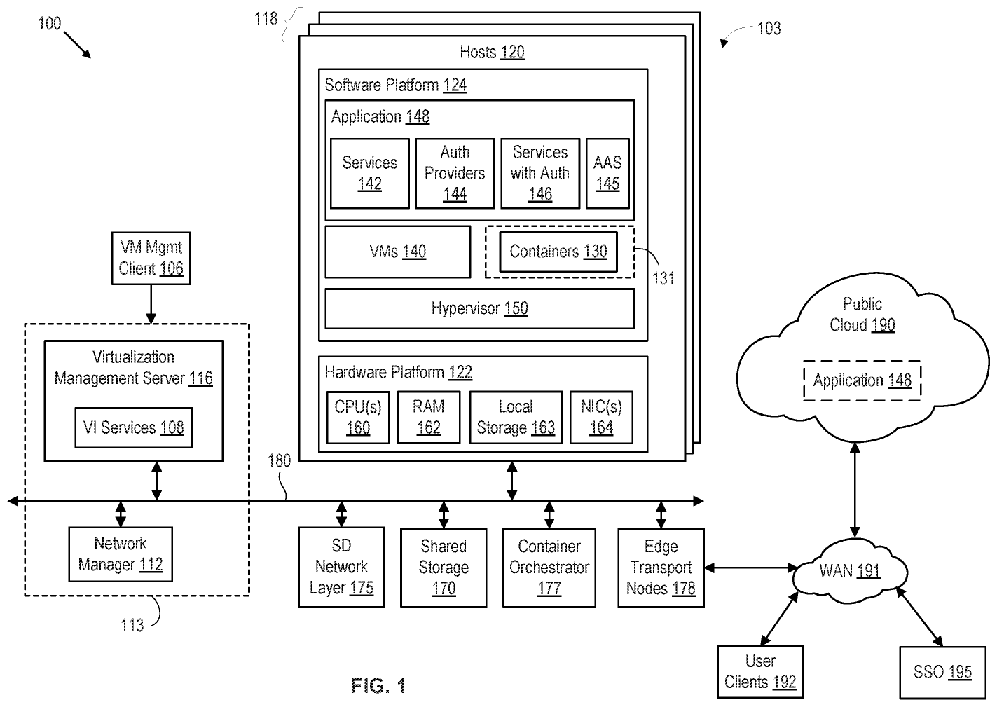

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein.

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170. Virtualization management server 116 can select which local storage devices in hosts 120 are part of a vSAN for host cluster 118.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif.

Host cluster 118 is configured with a software-defined (SD) network layer 175. SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to wide area network (WAN) 191 (e.g., a corporate network, the public Internet, etc.). Edge transport nodes 178 can include a gateway between the internal logical networking of host cluster 118 and the external network. Edge transport nodes 178 can be physical servers or VMs. For example, edge transport nodes 178 can be implemented in VMs 140 and include a gateway of SD network layer 175. Various clients 119 can access service(s) in virtualized computing system through edge transport nodes 178 (including VM management client 106 and user clients 192).

Virtualization management server 116 is a physical or virtual server that manages host cluster 118 and the virtualization layer therein. Virtualization management server 116 installs agents) in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. In this manner, host cluster 118 can be a cluster of transport nodes. One example of an SD networking platform that can be configured and used in embodiments described herein as network manager 112 and SD network layer 175 is a VMware NSX® platform made commercially available by VMware, Inc. of Palo Alto, Calif.

Virtualization management server 116 and network manager 112 comprise a virtual infrastructure (VI) control plane 113 of virtualized computing system 100. Virtualization management server 116 can include various VI services 108. VI services 108 include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

A VI admin can interact with virtualization management server 116 through a VM management client 106. Through VM management client 106, a VI admin commands virtualization management server 116 to form host cluster 118, configure resource pools, resource allocation policies, and other cluster-level functions, configure storage and networking, and the like.

In embodiments, virtualized computing system 100 can include a container orchestrator 177. Container orchestrator 177 implements an orchestration control plane, such as Kubernetes®, to deploy and manage applications or services thereof on host cluster 118 using containers 130. In embodiments, hypervisor 150 can support containers 130 executing directly thereon. In other embodiments, containers 130 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150 (referred to as a pod VM controller). Container orchestrator 177 can include one or more master servers configured to command and configure pod VM controllers in host cluster 118. Master server(s) can be physical computers attached to network 180 or VMs 140 in host cluster 118.

In an embodiment, software platform 124 includes an application 148. Application 148 includes software deployed in one or more VMs 140, one or more containers 130, or a combination of VMs 140 and containers 130. For example, the software of application 148 can include services 142, authorization providers 144, services 146 with an authorization model, and an authorities aggregator service (AAS) 145. Services 142 comprise components of application 148 for executing the workload. Application 148 can include one or more services 142 for performing various functions. One or more of services 142 can be accessible by users through user clients 192 connected to WAN 191. Before accessing services 142, users authenticate using an SSO, such as SSO 195 coupled to WAN 191. By way of example, SSO 195 is described as an external service configured for authenticating users. However, in embodiments, SSO 195 can be a service in virtualization management server 116 or a third-party service executing in a physical server or VM within host cluster 118. SSO 195 provides an authentication scheme that allows a user to access (e.g., with a single username and password) services 142 in application 148.

Authorization providers 144 are services of application 148 that include authorization information for users. Authorization information can include role-based access control (RBAC) information. RBAC is a mechanism to grant users the access to services 142 or resources managed by application 148 (e.g., storage resources, network resources, etc.) based on the roles that each of the users has assigned. While not common practice, RBAC also can be used to deny users access to services/resources. Authorization information can include permission-based access control (PBAC) information. PBAC is a mechanism to grant or deny users the access to services 142 or resources based on the permissions that each user has assigned. Typically, PBAC is combined with RBAC to group related permissions into a single role, which allows administrators to assign a single role to a user instead of assigning multiple permissions individually. Authorization providers 144 maintain RBAC and/or PBAC information for users accessing services 142 and associated resources. Authorization providers 144 provide authorities to services 142. An authority is a role (in RBAC) or permission (in MAC) that, when assigned to a user, grants the user the ability to perform certain actions.

Services 146 are services of application 148 that add authorization semantics to the user data they manage, which is independent of any SSO provider (SSO 195) or authorization service (authorization providers 144). An example service 146 is a service that exposes the concept of a “project.” A user can be a member of a project or an administrator of a project. This information is stored within a project service, for example, rather than within an authorization provider 144 or SSO 195. While a project service is one example of services 146, those skilled in the art will appreciate that other types of services can have similar authorization semantics separate from SSO providers and authorization providers.

Accordingly, a service 142 may need to collect and homogenize authorization information from various sources to decide whether a user request can be accepted from an authorization point of view. In the embodiments, these sources include authorization providers 144, services 146 with authorization semantics, and SSO 195. In embodiments, AAS 145 provides an authorities aggregator for services 142. AAS 145 is configured to gather, for a given user of application 148, the authorities that the user is granted across the different sources (e.g., SSO, RBAC, PBAC, custom services with authorization semantics, etc.). In embodiments, AAS 145 is preconfigured with knowledge of the various sources of the authorities. In other embodiments, authorities sources can register with AAS 145 dynamically over time as such sources are provisioned and become available. Operation of AAS 145 is described further below.

In embodiments, virtualization computing system 100 is implemented as a hybrid cloud. Host cluster 118, control plane 113, SD network layer 175, shared storage 170, container orchestrator 177, and edge transport nodes 178 can be part of a virtualized computing system 103. In one embodiment, virtualized computing system 103 may be a data center controlled and administrated by a particular enterprise or business organization, while a public cloud 190 is operated by a cloud computing service provider and exposed as a service available to account holders, such as the particular enterprise in addition to other enterprises. As such, virtualized computing system 103 may sometimes be referred to as an on-premise data center(s). In embodiments, application 148 can include services (e.g., any of services 142, authorization providers 144, services 146, or AAS 145) deployed and executing in public cloud 190. Thus, AAS 145 (whether executing in a host 120 or public cloud 190) can aggregate authorities from sources in host cluster 118 and/or public cloud 190 for services executing in host duster 118 and/or public cloud 190.

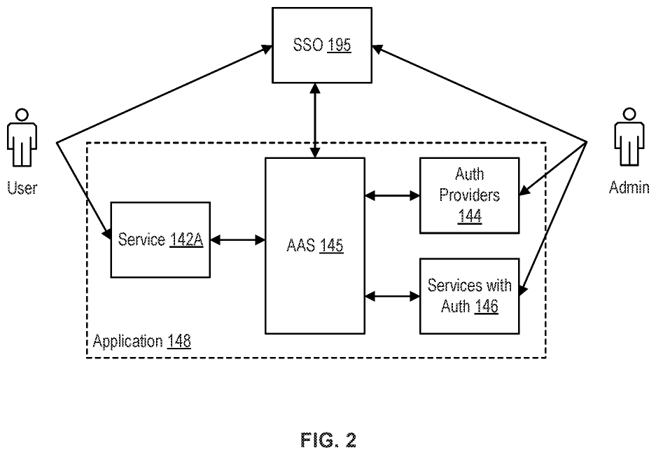

FIG. 2 is a block diagram depicting user interaction with an application 148 according to an embodiment. Application 148 includes a service 142A, AAS 145, authorization providers 144, and services 146 with authorization semantics. An administrator configures authorization providers 144 and services 146 with authorization information for users. The administrator can also configure authorization information in SSO 195. That is, in some embodiments, SSO 195 can provide some authorization information along with authenticating the user. AAS 145 interfaces with authorization providers 144, services 146, and/or SSO 195 to obtain authorization information for a user upon request by service 142A. AAS 145 collects and aggregates the authorization information from the disparate sources and returns the aggregated authorization information to service 142A in an authorization context.

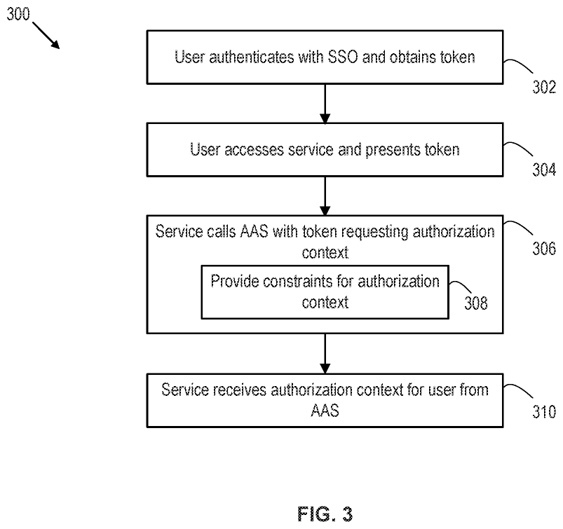

FIG. 3 is a flow diagram depicting a method 300 of aggregating authorization information for a user according to an embodiment. As a prerequisite, an administrator configured all the authority sources for the users (e.g., authority information in the SSO provider, authority providers, services with authority semantics, etc.). Method 300 begins at step 302, where a user authenticates with SSO 195 and obtains a security token. The security token grants the user access to different services 142 of application 148 (e.g., service 142A). In embodiments, the security token does not include any authorization information, that is, no information as to what the user can or cannot do within each service. In other embodiments, the security token may include some authorization information (e.g., RBAC, PBAC, etc.). In still other embodiments, SSO 195 can maintain some authorization information, but does not provide such information in the security token. Rather, SSO 195 provides authority information upon request, as discuss further below. One example of a security token is a JavaScript Object Notation (JSON) Web Token (JWT) as described in RFC 7519. However, the techniques described herein are not limited to any particular format of the security token.

At step 304, the user access service 142A and presents the security token received from SSO 195. Security token represents to service 142A that the user has been authenticated by SSO 195 and has permission to access service 142A. At step 306, service 142A calls AAS 145 with the security token as parametric input requesting an authorization context for the user. In some embodiments, service 142A can request the entire authorization context for the user from AAS 145. In other embodiments, service 142A can provide constraints for the authorization context (step 308). For example, service 142A can request an authorization context for the user, but with the context for a particular service or services, rather than the entire authorization context. At step 310, service 142A receives the authorization context for the user from AAS 145. The process for obtaining authorization information and generating the authorization context is described below.

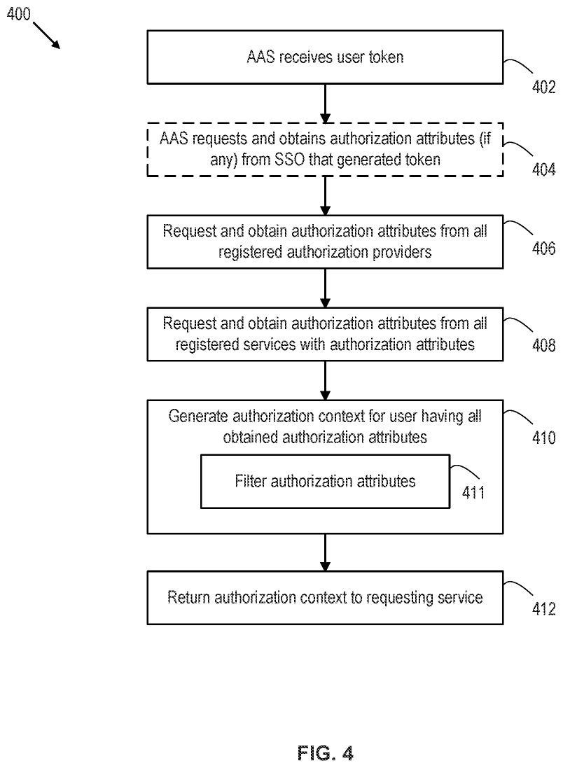

FIG. 4 is a flow diagram depicting a method 400 of generating an authorization context for a user by aggregating authorization information from disparate sources according to an embodiment. Method 400 begins at step 402, where AAS 145 receives the security token for the user from a requesting service (e.g., service 145A). At step 404, AAS 145 can optionally request and obtain authorization information from SSO 195 that generated the security token. AAS 145 can be configured with knowledge of the SSO 195 or can obtain information for communicating with SSO 195 from the security token. SSO 195 can return any authorization information it has or can indicate to AAS 145 that no authorization information for the user is available.

At step 406, AAS 145 requests and obtains authorization information from all registered authorization providers (e.g., authorization providers 144). At step 408, AAS 145 requests and obtains authorization information from all registered services having authorization semantics (e.g., services 146). At step 410, AAS 145 generates an authorization context for the user having the obtained authorization information in the aggregate. In embodiments where service 142A has provided constraints for the authorization context, AAS 145 can filter the authorization information based on the constraints. Alternatively, AAS 145 can apply the filter in steps 406 and 408 when requesting the authorization information. At step 412, AAS 145 returns the authorization context to the requesting service (e.g., service 142A).

For example, a user can receive a security token in JTW format that looks like the following:

```
{
  {
  ″alg″: ″RS256″,
  ″typ″: ″JWT″,
  ″kid″: ″signing_2″
  },
  {
      ″sub″: ″vmware.com:34cd0b83-ad51-42b1-a3ba-242e30f2653a″,
      ″iss″: ″https://gaz-preview.csp-vidm-prod.com″,
      ″context_name″: ″e3f2b0c3-6a93-4b7d-a1e7-b075a2cf9e57″,
      ″azp″: ″cspservice″.
      ″domain″: ″vmware.com″,
      ″perms″: [
        ″csp:org_owner″,
        ″csp: org_member″,
        ″exteral/P66zMDaYA3ZjTGURLXLazQr91tM_/cspservice1:user″,
        ″external/YwdHyBeQzjCXkL2wQSeGwauJ5mA_/cspser-
        vice2:admin″
      ],
      ″exp″: 1617046698,
      ″iat″: 1617017898,
      ″jti″: ″404d8149-460a-4351-aeff-3b1d40664cf9″,
      ″acct″: ″theuser@vmware.com″,
      ″username″: ″theuser″
    },
    ...
}
```

The user can have different roles assigned, each of which can have a different set of permissions. AAS 145 receives authorization information from a custom RBAC provider that can look as follows:

```
// for the roles assigned to the user
{
  ″content″: [
    {
      ″orgId″: ″e3f2b0c3-6a93-4b7d-a1e7-b075a2cf9e57″,
      ″principalId″: ″theuser@vmware.com″,
      ″principalType″: ″user″,
      ″roles″: [
      ″7b83c36f-a1c0-449f-bc94-ceed0d758410″,
      ″613b37f1-add2-4ca4-a2d5-94e0e93922e2″
      ]
    }
  ],
  ...
}
// for the permissions assigned to one of the roles
{
  ″id″: ″7b83c36f-a1c0-449f-bc94-ceed0d758410″,
  ″name″: ″role 1″,
  ″description″: ″role 1 description″,
  ″orgId″: ″e3f2b0c3-6a93-4b7d-a1e7-b075a2cf9e57″,
  ″permissions″: [
    ″permission11″
    ″permission12″
  ],
  ...
}
```

The user can belong to different projects, with a different level of responsibility within each project. AAS 145 can receive authorization information from a project service having an RBAC model that looks as follows:

```
// for the users that belong to one of the projects
{
  ″id″: ″fc80505e-e9ab-4670-81c6-aef03b3cd099″,
  ″name″: ″projectXYZ″,
  ″description″: ″project XYZ description″,
  ″orgId″: ″e3f2b0c3-6a93-4b7d-a1e7-b075a2cf9e57″,
  ″administrators″: [
    {
    ″principalId″: ″theuser@vmware.com″
    },
    ...
  ],
  ″members″: [
    {
    ″principalId″: ″anotheruser@vmware.com″
    },
    ...
  ],
  ...
}
```

AAS 145 gathers authorization information for the user from the disparate sources and generates a uniform authorization context that can look as follows:

```
// e.g. GET https://api.ourapplication.com/aas/api/auth-context
// with user’s JWT token in the Authorization header
{
  ″userRoles″: [
    ″csp:org_owner″, // from SSO
    ″csp:org_member″,
    ″external/P66zMDaYA3ZjTGURLXLazQr91tM_/cspservice1:user″,
    ″external/YwdHyBeQzjCXkL2wQSeGwauJ5mA_/cspser-
    vice2:admin″,
    ″7b83c36f-a1c0-449f-bc94-ceed0d758410″, // from custom RBAC
    ″613b37f1-add2-4ca4-a2d5-94e0e93922e2″
  ],
  ″userPermissions″: [
    ″permission11″, // from custom RBAC role 1
    ″permission12″,
    ″permission21″, // from custom RBAC role 2
    ″permission22″,
    ″permission23″
  ],
  ″projects″: [ // from the project service model
    {
      ″projectId″: ″e61604d4-e0aa-4369-8532-f0e74ffa54e4″,
      ″userRoles″: [
        ″administrator″
      ]
    },
  {
      ″projectId″: ″7ca95a30-3a27-4fb3-b430-718a0465d5c3″
      ″userRoles″: [
        ″member″
      ]
    },
    ...
  ],
  ... // from other services, if needed
}
```

From that point, any service within the application that needs to do any authorization check for a user, can get such an authorization context for that user, and check whether that user has or has not the required role or permission. The details described above are mainly from the “consumption” point of view. AAS 145 has been configured properly and it is able to get and resolve requests for an authorization context for any of the users of the system or application. There is one pre-configuration step in that AAS 145 has to be configured to know the location of the authority sources. In one embodiment, the list of authority sources is configured with AAS 145. In another embodiment, authority sources can register with AAS 145 dynamically over time.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of aggregating authorization information for a user accessing a service executing in a virtualized computing system, the method comprising:
receiving, at an authorities aggregating service (AAS) executing in the virtualized computing system, a request for an authorization context for the user from the service;
requesting, by the AAS, authorization information from at least one authorization source registered with the AAS for the user;
generating the authorization context by aggregating the authorization information; and
returning the authorization context to the service.

2. The method of claim 1, wherein the request for the authorization context includes a security token issued to the user by a single sign-on (S SO) provider, and wherein the at least one authorization source includes the SSO provider.

3. The method of claim 1, wherein the at least one authorization source includes at least one authorization provider, each of the at least one authorization provider having role-based access control (RBAC) information, permission-based access control (PBAC) information, or both RBAC and PBAC information.

4. The method of claim 1, wherein the at least one authorization source includes a service having authorization semantics.

5. The method of claim 1, wherein the request for the authorization context includes constraints, and wherein the AAS filters the authorization information based on the constraints when generating the authorization context.

6. The method of claim 1, wherein the service and the AAS execute in one or more virtual machines, one or more containers, or both one or more virtual machines and one or more containers in a host cluster of the virtualized computing system.

7. The method of claim 1, wherein the at least one authorization source executes in the virtualized computing system, a public cloud, or both the virtualized computing system and the public cloud.

8. A non-transitory computer readable medium comprising instructions to be executed in a computing device to cause the computing device to carry out a method of aggregating authorization information for a user accessing a service executing in a virtualized computing system, the method comprising:
receiving, at an authorities aggregating service (AAS) executing in the virtualized computing system, a request for an authorization context for the user from the service;
requesting, by the AAS, authorization information from at least one authorization source registered with the AAS for the user;
generating the authorization context by aggregating the authorization information; and
returning the authorization context to the service.

9. The non-transitory computer readable medium of claim 8, wherein the request for the authorization context includes a security token issued to the user by a single sign-on (SSO) provider, and wherein the at least one authorization source includes the SSO provider.

10. The non-transitory computer readable medium of claim 8, wherein the at least one authorization source includes at least one authorization provider, each of the at least one authorization provider having role-based access control (RBAC) information, permission-based access control (PBAC) information, or both RBAC and PBAC information.

11. The non-transitory computer readable medium of claim 8, wherein the at least one authorization source includes a service having authorization semantics.

12. The non-transitory computer readable medium of claim 8, wherein the request for the authorization context includes constraints, and wherein the AAS filters the authorization information based on the constraints when generating the authorization context.

13. The non-transitory computer readable medium of claim 8, wherein the service and the AAS execute in one or more virtual machines, one or more containers, or both one or more virtual machines and one or more containers in a host cluster of the virtualized computing system.

14. The non-transitory computer readable medium of claim 8, wherein the at least one authorization source executes in the virtualized computing system, a public cloud, or both the virtualized computing system and the public cloud.

15. A virtualized computing system, comprising:
a cluster of hosts each having a hypervisor supporting execution of virtual machines; and
an application, executing on one or more of the virtual machines, including a plurality of services and an authorities aggregation service (AAS), the AAS configured to aggregate authorization information for a user accessing a service of the plurality of services by:
receiving, at an authorities aggregating service (AAS) executing in the virtualized computing system, a request for an authorization context for the user from the service;
requesting, by the AAS, authorization information from at least one authorization source registered with the AAS for the user;
generating the authorization context by aggregating the authorization information; and
returning the authorization context to the service.

16. The virtualized computing system of claim 15, wherein the request for the authorization context includes a security token issued to the user by a single sign-on (SSO) provider, and wherein the at least one authorization source includes the SSO provider.

17. The virtualized computing system of claim 15, wherein the at least one authorization source includes at least one authorization provider, each of the at least one authorization provider having role-based access control (RBAC) information, permission-based access control (PBAC) information, or both RBAC and PBAC information.

18. The virtualized computing system of claim 15, wherein the at least one authorization source includes a service having authorization semantics.

19. The virtualized computing system of claim 15, wherein the request for the authorization context includes constraints, and wherein the AAS filters the authorization information based on the constraints when generating the authorization context.

20. The virtualized computing system of claim 15, wherein the at least one authorization source executes in the host cluster, a public cloud, or both the host cluster and the public cloud.
